(19) United States
(12) Patent Application Publication
(10) Pub. No.: US 2013/0284391 A1
(43) Pub. Date: Oct. 31, 2013

(54) Method and Device for Producing a Coated Structural Element

(71) Applicant: HÖRMANN KG BROCKHAGEN, Steinhagen (DE)

(72) Inventor: Michael Brinkmann, Halle (DE)

(73) Assignee: HÖRMANN KG BROCKHAGEN, Steinhagen (DE)

(21) Appl. No.: 13/849,981

(22) Filed: Mar. 25, 2013

(30) Foreign Application Priority Data
Apr. 27, 2012 (DE) 102012008616.4

(51) Int. Cl. B22D 11/126; B05D 3/00; B05D 3/06; B05D 1/02

(52) U.S. Cl. CPC B22D 11/126; B05D 1/02; B05D 3/002; B05D 3/065
USPC 164/69.1; 427/424; 427/290; 427/558; 427/8

(57) ABSTRACT

A method for producing a coated structural element for exterior applications in the door and gate industry, such as for a sectional gate panel, an overhead door, a door, or a structural element for a facade with an integrated gate and/or integrated door, in which a relative movement between a starting material designed for producing the structural element and a coating device is generated along a feed direction, and to a coating mass that is applied to the starting material by the coating device along a coating direction that runs transverse to the feed direction and preferably approximately perpendicular to the surface to be coated.

### CROSS-REFERENCE TO RELATED APPLICATIONS

This application is based on and claims priority to German Patent Application No. 10 2012 008 616.4, filed on Apr. 27, 2012, which is incorporated herein by reference in its entirety.

### STATEMENT REGARDING FEDERALLY SPONSORED RESEARCH OR DEVELOPMENT

Not applicable.

### BACKGROUND OF THE INVENTION

In conventional methods, to obtain the weather resistance required for exterior applications, structural elements for exterior applications that are coated on one surface with a colored lacquer or the like are spray painted in a spraying booth or painted with a protective lacquer in a dip process. In such methods for applying a top coat, a layer thickness of more than 60 μm, generally between 80 and 100 μm, the thickness of which cannot be precisely set, is obtained on the surface of the structural element. As a rule, this layer thickness is not required to obtain the desired weather resistance. Furthermore, when applying the protective lacquer there is a loss of lacquer, because some of the protective lacquer does not make to the structural element or does not make it to the desired location on the structural element. This loss of lacquer is especially high with the known spray methods in spraying booths and accounts for up to one-third or more of the lacquer material used.

Not only does this lead to disposal problems, it also has economic disadvantages because lost lacquer must also be paid for per unit of surface area for the structural element.

For solving these problems, DE 10 2009 041 860 A1 proposes a method for producing structural elements and a device suitable for executing such methods in which the protective lacquer or a weather-resistant coating material, that in addition may also be very scratch resistant and have very good UV resistance, is applied to the structural element using nozzles of a conventional ink jet printer. This attains a coating thickness of 6 to 7 μm, which is entirely sufficient for obtaining the desired weather resistance while no appreciable loss of lacquer occurs.

In the known methods, a construction component that may where necessary also be provided a decorative surface, such as for instance an imprint, is forwarded to a coating station. With the coating station, a layer of a preferably at least somewhat transparent protective lacquer, which layer is closed at least in areas, is applied to the structural element in a through-feed method. The use of nozzles from conventional ink jet printers ensures that the closed layer constitutes individual droplets that are printed onto the surface by at least one row of print heads. Finally, the coating is cured, for instance using UV light, in the known method.

With these known methods, it is possible to solve the technical disposal and economic problems associated with the conventional dipping or spraying methods. However, it has been found that in some cases there may be weather-induced damages in the area of the coating.

Given this problem in the prior art, the object of the invention is to create methods and devices for producing a coated construction component, with which methods and devices the economic and ecological problems associated with the known dipping and spraying methods are solved and reliable weather resistance is also achieved.

### BRIEF SUMMARY OF THE INVENTION

The invention relates to a method for producing a coated structural element for exterior applications in the door and gate industry, such as for a sectional gate panel, an overhead door, a door, or a structural element for a facade with an integrated gate and/or integrated door, in which a relative movement between a starting material designed for producing the structural element and a coating device is generated along a feed direction, and to a coating mass that is applied to the starting material by the coating device along a coating direction that runs transverse to the feed direction and preferably approximately perpendicular to the surface to be coated.

### BRIEF DESCRIPTION OF THE DRAWINGS

FIG. 1 is a schematic depiction of an inventive device for producing a coated construction element;

FIG. 2 is a view of a print head in the device according to FIG. 1 from below; and,

FIG. 3 is a detail of a coated structural element.

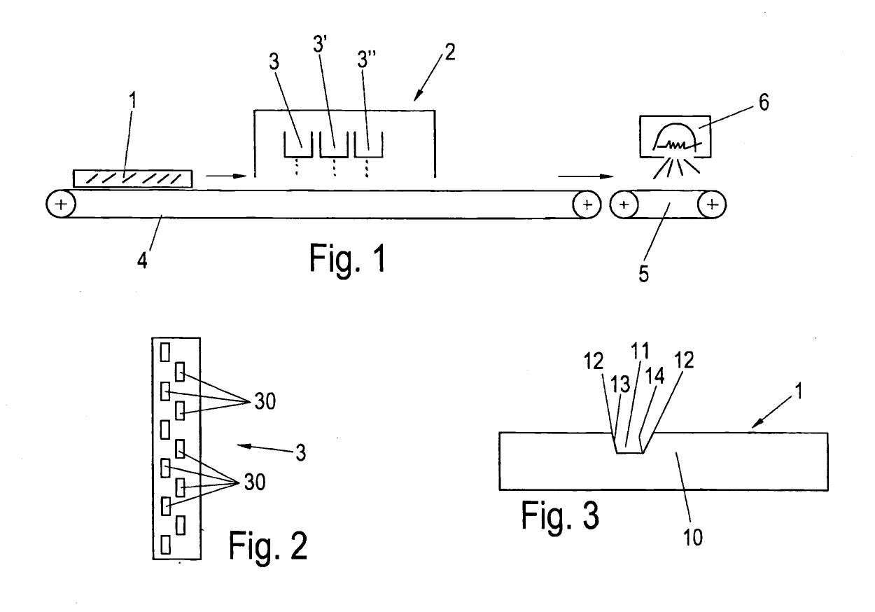

### DETAILED DESCRIPTION OF PREFERRED EMBODIMENT

The invention relates to a method for producing a coated structural element for exterior applications in the door and gate industry, such as for a sectional gate panel, an overhead door, a door, or a structural element for a facade with an integrated gate and/or integrated door, in which a relative movement between a starting material designed for producing the structural element and a coating device is generated along a feed direction, and to a coating mass that is applied to the starting material by the coating device along a coating direction that runs transverse to the feed direction and preferably approximately perpendicular to the surface to be coated.

In accordance with the invention, this object is attained using a refinement of the known methods, which refinement is essentially characterized in that the quantity of the coating mass per surface element running perpendicular to the coating direction and applied from the coating plane covered by the coating device during the relative movement between the starting material and the coating device is a function of material data that characterize the starting material.

This invention draws on the understanding that the problems observed in the prior art can primarily be traced back to the fact that especially for profiled limiting surfaces of the structural elements in the area of the profiles an insufficient quantity of the coating mass is applied so that there are gaps within the coating and as a consequence of this there are also weather-induced damages to the structural element surface, which where necessary is already imprinted. Similar problems are found with structural elements constituted from different materials.

In the inventive method, this deficiency is eliminated in that the quantity of the applied coating mass is controlled taking into consideration material data that characterize the starting material, such as for instance material data that indicate material properties and/or material data that depict a surface topology of the structural element.

When coating profiled structural elements it has proved particularly advantageous when the quantity of the coating mass applied per surface element of the coating plane is controlled as a function of the surface or surface area of a limiting surface element of the structural element covered by the surface element when the surface element is projected onto the limiting surface of the starting material along the coating direction. What can be attained in this manner is that a desired quantity of the coating mass may be applied to each limiting surface element regardless of surface topology and a corresponding layer thickness is obtained. The control may be conducted such that taking into consideration a three-dimensional profile of the structural element that is stored in a data processing system (computer), the quantity of coating material expelled from the nozzle application device (print heads) in the movement plane of the structural element (coating plane) is precisely varied such that a precisely constant layer thickness results on the three-dimensional structural element surface. For calculating the expelled quantity of the coating material, the angle a between the structural element surface and the movement plane (coating plane) of the structural element is calculated from the three-dimensional model at each location and the quantity of the expelled coating mass is calculated using the formula

Coating quantity=Normal quantity×1/sin α

The normal quantity is the coating quantity needed for coating a flat limiting surface of the structural element that runs parallel to the coating plane. What this can achieve is that the same quantity of the coating mass per limiting surface element is applied to at least a portion of the limiting surface of the starting material.

As may be taken from the explanation in the forgoing, the material data may have the topology data depicting the topology of the limiting surface to be coated, the quantity of the coating mass applied to the starting material being a function of these topology data.

In the context of a desired reduction in the data required for this control, the topology data may be formed from the type data describing the topology type (for instance panel, crimping, or the like) and the scale data indicating the size of the construction component. It is assumed that the topology type is formed by ratios between the individual dimensions of the profile elements determining the topology and the size of the individual profile elements is described by the scaling data depending on the structural element dimensions.

When executing the inventive methods, first a limiting surface of the structural element, which limiting surface may have a decorative surface, is conducted to a coating station and then a layer of the coating mass, which layer is closed at least in sections, and which coating mass is for instance an at least somewhat transparent protective lacquer, is applied in a through-feed method. The closed layer constitutes individual droplets that are printed using at least one print head onto the limiting surface of the structural element. The structural element may be coated untreated. However, it is also possible for a structural element already provided with a decorative element, for instance imprinted, to be provided with a coating mass in order to attain the desired weather resistance. The coating mass is cured after it is applied. By printing the coating mass using a print head nozzle or a print head, both the layer thickness and the position of the individual droplets of the layer can be precisely controlled. This permits lacquer losses to be reduced to a minimum, for instance to losses of less than 1%, preferably less than 0.1%.

With respect to the desired weather resistance and the desired reduction in material usage, with the invention it has proved particularly advantageous when the coating mass is printed with a thickness between 5 and 60 μm, especially between 8 and 40 82 m, onto the limiting surface, such as for instance a limiting surface of a structural element that is already provided with a decorative element. According to this, the layer thickness is significantly thinner than with conventional application using a spraying method.

The invention also provides that more coating mass per limiting surface, especially 20 to 50% more coating mass per limiting surface, is applied to individual limiting surface elements of a first limiting surface area than to the individual limiting surface elements of a second limiting surface area in order to thus adjust the coating to the expected weather effects and/or material properties of the structural element while avoiding unnecessarily high material usage. Areas that are subject to more severe weathering can be protected better with a coating mass than areas that are subject to less severe weathering.

The structural element may be present in different forms, e.g., in part plate-like with an essentially flat, two-dimensional limiting surface, especially a decorative surface, but with certain three-dimensional structural elements, e.g., depressions and elevations in the range of millimeters to several centimeters. The depressions and/or elevations may be panel or crimp-like profiles.

In the following, those sections of a primarily flat, two-dimensional structure element that project either above or below the plane are called profiled. The use of structural elements with point-like profiles or ridge-like depressions or elevations of other types of profiles are also possible.

The structural element may have an at least partly profiled surface with edges or curves and the protective lacquer may be applied with a greater thickness than on flat areas of the limiting surface as a function of the material data depicting these profiles in the area of the edges or curves. It is thus possible to obtain greater protection by increasing the layer thickness of the protective lacquer, specifically in the area of the profiles.

Alternatively, it is also possible to control the layer thickness during printing such that in the area of profiles precisely the same layer thickness is attained as in the flat locations on the structural element in that the angle of the profiled portion is actually compensated as a function of the aforesaid three-dimensional profile data for the structural element.

Just as in the known method in accordance with DE 10 2009 041 860 A1, the starting material may be conveyed as a material strip, possibly a profiled material strip, in the feed direction with respect to the preferably stationary coating device. In this embodiment, a coating plane that is also guided during the movement of the material strip is covered by the coating device.

As was already addressed in the foregoing, the starting material to be coated may have a decorative surface, for instance it may already be imprinted.

For obtaining the desired weather resistance, it has proved particularly favorable when a coating of the surface of the starting material that is closed at least by areas is formed with the coating material. In the inventive method, the coating mass constitutes individual droplets that are preferably applied to the surface to be coated by at least one print head row, particularly preferred by two, three, or more print head rows arranged one after the other in the direction of the feed path. When using two, three, or more print head rows arranged one after the other in the feed direction, it is possible to control the quantity of coating mass in that the print head rows arranged one after the other are activated individually and independently of one another for dispensing the coating mass.

As may be taken from the aforesaid explanation of the inventive methods, the coating mass usefully has an ink and/or a protective lacquer that is at least somewhat transparent.

Likewise, as in the known method in accordance with DE 10 2009 041 860 A1, for obtaining the starting material a metal band may be drawn from a supply (coil) in a continuous process, subjected to processing such as for instance forming, especially cold forming, then coated, especially imprinted, and where necessary cut into pre-specified lengths in the direction running transverse to the feed direction.

For obtaining a desired gloss value, the surface of the coating applied to the starting material may be matted. In one particularly preferred embodiment of the invention, this may be achieved in that the surface is irradiated with UV light pulses preferably having a wavelength of less than 200 nm, esp. about 192 nm, the light pulses having a period of less than 100 ns, preferably less than 20 ns, and the surface being acted upon with a power of 106 W/cm2 during the period of the light pulses.

In such a method, which is also called an Excimer method, a microstructure is produced in the area of the surface of the coating mass that leads to the desired gloss or to the desired matte appearance.

As may be taken from the explanation of the inventive method in the foregoing, a device for executing such methods has a feed device for feeding a structural element to be coated to a coating station, a coating station for applying a coating mass, such as for instance an at least somewhat transparent protective lacquer, in the through-feed method, and where necessary a matte device, the coating station having at least one digital print head row, preferably two, three, or more print head rows arranged one after the other in the direction of feed, with which print heads the coating mass is printed onto the decorative surface by forming individual droplets, and, where necessary, a station for curing the preferably at least somewhat transparent coating mass.

The invention shall be explained in the following using the drawings, which are explicitly referenced with respect to all invention-essential details that were not described in greater detail in the specification.

An essentially plate-like structural element 1, especially a panel of a sectional door leaf, is fed on a conveyor mechanism 4 in the form of a conveyor belt to a digital print station 2. Disposed inside the digital print station 2 is one or a plurality of rows of digital print heads 3 that extend essentially across the entire width transverse to the feed direction of the structural element 1. The structural element 1 may have a decorative surface on its upper side that may be imprinted or coated in one or a plurality of colors. With the print station 2, the print heads 3 apply a protective lacquer to a limiting surface of the structural element 1 in a single pass method.

For this, the structural element 1 passes at a continuous advancing speed through the digital print station 2, the protective lacquer being applied to the surface of the structural element 1 in the form of small droplets from the one or plurality of print head rows 3. The size of the individual droplets is between 1-500 pl (picoliters), especially 10 to 200 pl, it being possible to vary the volume of the individual droplets in the given area using a control. The distance from one droplet to another, both in the X direction (feed direction) and also perpendicular thereto in the Y direction, i.e., both in the feed direction and transverse to the feed direction, is between 1 and 300 especially preferred between 10 and 100 μm.

Depending on the protective lacquer used that is applied from the different print head rows 3, two, three, or more print head rows 3, 3′, 3″ are used one after the other in the feed direction in order to produce a closed surface with the protective lacquer. Each print head row 3, 3′, 3″ may apply droplets of protective lacquer to the limiting surface of the structural element 1. Two or more than three print head rows may also be arranged one after the other instead of the three print head rows 3, 3′, 3″.

FIG. 2 depicts, from below, the print head row 3, in which individual print heads 30 are provided that are arranged offset to one another and cover the entire width of the structural element 1 transverse to the feed direction of the structural element 1. Each print head includes a plurality of nozzles and each nozzle can be activated individually via an electronic control in order to vary the droplet size or the droplet volume and the number of droplets.

The electronic control of the digital print station 2 is used to imprint the precise contours of the limiting surface of the structural element 1 with the protective lacquer and to prevent overspray in front of, behind, or lateral to the structural element 1. Likewise, this electronic control is used in order to attain an appropriately high application per surface on potentially three-dimensional areas of the structural element 1, e.g., on a profile, so that areas there are produced with a thicker layer thickness.

Arranging the individual print heads in the print head rows 3, 3′, 3″ appropriately and having an appropriate number of print head rows and an appropriate selection of droplet volume and number of droplets per print head attains a desired layer thickness on the structural element 1 of for instance 10 μm.

After the protective lacquer has been applied, the structural element 1 is moved by means of a conveyor device 5 through a drying unit 6 with a UV radiator in which the layer of protective lacquer is cured.

It is also possible to use as an alternative embodiment a protective lacquer containing a solvent that cures using evaporation, without UV curing. A third embodiment could be a combination of a UV-curing protective lacquer that includes certain portions of solvent that must evaporate off prior to the passage through the UV-curing station. Alternatively, it is also possible to use a water-based lacquer that dries purely physically without UV curing.

Another interesting embodiment results from special curing by means of very intensive short-wave UV radiation. This process, called “Excimer,” leads to the surface of the applied protective lacquer curing first and contracting, thus resulting in a matte surface, before the entire layer of lacquer is cured in a further final curing process. This results in a desired matte protective lacquer surface without it being necessary to mix into the protective lacquer particle matting agents otherwise normally used.

FIG. 3 depicts a structural element 1 that has a plate or panel-shaped body 10 on the upper side of which is embodied a decorative surface that has a crimp 11 in the form of a groove-like depression that may extend longitudinally or transversely in the structural element 1. The crimp 11 has at the transition to the flat decorative surface edges 12 that may be particularly stressed mechanically. Therefore, when the structural element 1 is being imprinted the area of the two edges 12 is printed with a thicker layer thickness than the other areas farther away from the edges 12. The layer thickness at the edges 12 may be as thick, thicker, more than 20% thicker, or even more than two or three times as thick as at the thinner areas. In addition, the crimps 11 are also imprinted with protective lacquer on the side walls 13 and bottom 14. The protective lacquer may be applied with a thickness between 5 to 25 μm, especially 8 to 15 μm, in the thinner areas.

The protective lacquer itself may be constituted very differently; in one preferred embodiment it comprises an acrylate mixture.

The viscosity of the protective lacquer is preferably between 5-30 cSt (centistokes) at 25° C.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth or shown in the accompanying drawings are to be interpreted as illustrative, and not in a limiting sense. While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

What is claimed and desired to be secured by Letters Patent is as follows:

1. A method for producing a coated structural element for exterior applications in a door and gate industry, said method comprising:
providing a starting material having a surface to be coated;
generating relative movement between said starting material and a coating device along a feed direction; and
coating said starting material along a coating direction, said coating direction running transverse to said feed direction and approximately perpendicular to said surface to be coated; and
wherein a quantity of a coating mass applied per surface element of a coating plane running perpendicular to the coating direction and applied by the coating device during said relative movement between the starting material and the coating device is a function of material data that characterize the starting material.

2. The method of claim 1 wherein said quantity of the coating mass applied per surface element of the coating plane is controlled as a function of a surface area of a limiting surface element of the starting material covered by the surface element when the surface element is projected onto the limiting surface of the starting material along the coating direction.

3. The method of claim 2 wherein the same quantity of the coating mass per limiting surface element is applied to at least a portion of the limiting surface of the starting material.

4. The method of claim 2 wherein said material data comprises topology data depicting a topology of the limiting surface element to be coated and said quantity of the coating mass applied to the starting material is controlled as a function of the topology data.

5. The method of claim 4 wherein said topology data are formed from type data describing the topology type and scale data.

6. The method of claim 2 wherein more coating mass per limiting surface element is applied to individual limiting surface elements of a first limiting surface area than to the individual limiting surface elements of a second limiting surface area.

7. The method of claim 6, wherein 20 to 50% more coating mass per limiting surface is applied to individual limiting surface elements of the first limiting surface area.

8. The method of claim 1 wherein the generating relative movement step comprises conveying said starting material in the feed direction with respect to a stationary coating device.

9. The method of claim 1 wherein said starting material having said surface to be coated has a decorative surface.

10. The method of claim 9 wherein said starting material is imprinted to obtain the decorative surface.

11. The method of claim 1 wherein said coating has closed areas on at least sections of the surface of the starting material.

12. The method of claim 1 wherein said coating device generates individual droplets of coating material that are applied to the surface to be coated by at least one print head row.

13. The method of claim 1 wherein said coating comprise one or more of an ink or protective lacquer that is somewhat transparent.

14. The method of claim 1 wherein said providing step comprises drawing a metal band from a supply in a continuous process, imprinting said metal band, and cutting said metal band into pre-specified lengths in a direction running transverse to the feed direction.

15. The method of claim 1 wherein said providing step comprises drawing a metal band from a supply in a continuous process and subjecting the metal band to a forming step.

16. The method of claim 15 wherein said forming step involves subjecting said metal band to a cold forming step.

17. The method of claim 15 wherein said providing step comprises imprinting said metal band with a decorative surface.

18. The method of claim 1 wherein said metal band is cut into pre-specified lengths in a direction running transverse to the feed direction.

19. The method of claim 1 wherein said coating forms a matted surface on the starting material.

20. The method of claim 1 further comprising the steps of irradiating said matted surface with ultraviolent light pulses having a wavelength of less than 200 nm and a period of less than 100 ns.

21. The method of claim 1 wherein said coated structural element comprises an element selected from the group consisting of a sectional gate panel, an overhead door, a door, or a structural element for a facade with an integrated gate or an integrated door.

22. The method of claim 1, wherein the method comprises the steps of:
determining a desired normal quantity (NQ) of coating mass applied to a flat surface of said starting material;
determining an angle a between a limiting surface element of said starting material and the coating plane; and
determining said quantity of coating mass applied to said limiting surface element according Coating Quantity=NC/(sin α).
